(19) United States
(12) Patent Application Publication
(10) Pub. No.: US 2012/0322001 A1
(43) Pub. Date: Dec. 20, 2012

(54) DEVELOPING AGENT AND IMAGE FORMING APPARATUS

(75) Inventors: Taishi Takano, Shizuoka-ken (JP); Tsuyoshi Itou, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/491,984

(22) Filed: Jun. 8, 2012

Related U.S. Application Data
(60) Provisional application No. 61/496,676, filed on Jun. 14, 2011.

(51) Int. Cl. G03G 9/00; G03G 15/08

(52) U.S. Cl. 430/105; 399/252; 430/109.1; 430/109.3; 430/109.4

(57) ABSTRACT

According to one embodiment, a developing agent includes a toner core particle containing a binder resin having a carboxyl group and a coloring agent and a surface layer formed on the toner core particle. The surface layer is formed by crosslinking the toner core particle, a water-soluble polymeric crosslinking agent which crosslinks with a carboxyl group and a water-soluble polymer having a carboxyl group in an aqueous medium. The developing agent can be fixed by a fixing device having a release oil applied thereto.

### CROSS-REFERENCE TO RELATED APPLICATIONS

This application is based upon and claims the benefit of priority from U.S. Provisional Application No. 61/496,676, filed on Jun. 14, 2011, the entire contents of which are incorporated herein by reference.

### FIELD

Embodiments described herein relate generally to a developing agent and an image forming apparatus.

### BACKGROUND

The low-temperature fixability of a toner is determined almost by the glass transition temperature of a binder resin, and there is a tendency that low-temperature fixing can be achieved by decreasing the glass transition temperature. However, at the same time, the thermal storage stability of a toner is deteriorated, and therefore, it is not easy to decrease the glass transition temperature of the binder resin.

In order to solve such a problem, there is a technique for encapsulating a toner by attaching and fusing resin particles to surfaces of particles to coat the surface of the toner with a surface layer made of a hard resin. However, if the thickness of the surface layer is increased, the low-temperature fixability is deteriorated, and therefore, it is necessary to decrease the thickness of the surface layer.

As such a technique, there is also a technique in which a polymerizable monomer is reacted on surfaces of toner particles. When a surface layer is formed using such a method, the low-temperature fixability can be ensured, however, it is necessary to make the surface layer thinner and harder so as to sufficiently satisfy the thermal storage stability.

Further, the thus prepared encapsulated toner can satisfy practicable low-temperature fixability in a monochrome mode and storage stability, but cannot ensure a fixing temperature margin in a full-color system.

### BRIEF DESCRIPTION OF THE DRAWINGS

FIG. 1 is an exemplary view showing an image forming apparatus according to an embodiment.

FIG. 2 is an exemplary view showing a fixing device shown in FIG. 1.

FIG. 3 is an exemplary view showing a high-pressure wet-type pulverizer.

### DETAILED DESCRIPTION

In general, according to one embodiment, a developing agent is configured to include toner core particles containing a binder resin having a carboxyl group and a coloring agent, and a surface layer formed on each of the toner core particles by crosslinking a water-soluble polymeric crosslinking agent which crosslinks with a carboxyl group and a water-soluble polymer having a carboxyl group in an aqueous medium. Further, the developing agent according to this embodiment is fixed by a fixing device having a release oil applied thereto.

Further, an image forming apparatus according to one embodiment includes an image carrying member, a developing device, and a fixing device which is disposed on the image carrying member and has a release oil application mechanism for applying a release oil. In this developing device, the above-described developing agent is contained.

When heating and fixing an encapsulated toner, in which a surface layer is formed on each toner core particle, on a transfer material such as paper, generally, the toner is softened by heating, thereby is fixed on the transfer material. At this time, however, a wax which is supposed to be melted along with the softening of the toner particles and emerge on the surfaces of the particles is blocked by the surface layers of the toner particles and there is a tendency that a sufficient effect cannot be exhibited. In the case of forming a monochrome image, since a small amount of a toner is fixed on a transfer material, it is possible to fix the toner without causing an image failure even with an internally added wax. However, in the case of forming a full-color image, since a large amount of a toner is fixed on a transfer material, a large adhesion force is generated between a fixing roller or a fixing belt and the image surface when fixing, and therefore, low-temperature or high-temperature offset tends to occur.

On the other hand, according to this embodiment, the developing agent is configured to include toner core particles containing a binder resin having a carboxyl group and a coloring agent, and a surface layer formed on each of the toner core particles by crosslinking a water-soluble polymeric crosslinking agent which crosslinks with a carboxyl group and a water-soluble polymer having a carboxyl group in a solvent, and therefore, a thinner and harder surface layer can be formed. In addition, by applying a release oil to be used when a toner obtained without adding a wax is fixed to a surface of a fixing member such as a fixing roller or a fixing belt, even a toner having a surface layer obtained by crosslinking can be fixed in full color, and therefore, both fixability at a low temperature and storage stability can be ensured.

Examples of the binder resin for the toner to be used in this embodiment include polyester resins, styrene-acrylic resins, polyurethane resins, and epoxy resins, and particularly, polyester resins can be selected from the viewpoint of fixing at a low temperature.

As for the polyester resins, for example, as raw material monomers for the polyester resins, a dihydric or higher polyhydric alcohol component and a divalent or higher polyvalent carboxylic acid component such as a carboxylic acid, a carboxylic anhydride, or a carboxylic acid ester are used.

Examples of the styrene-acrylic resins include styrene polymers, styrene-diene copolymers, and styrene-alkyl(meth)acrylate copolymers.

As the coloring agent to be used in this embodiment, a carbon black, an organic or inorganic pigment or dye, or the like is used.

As the carbon black, for example, acetylene black, furnace black, thermal black, channel black, and Ketjen black; and as the pigment or dye, for example, fast yellow G, benzidine yellow, indofast orange, irgajin red, carmen FB, permanent bordeaux FRR, pigment orange R, lithol red 2G, lake red C, rhodamine FB, rhodamine B lake, phthalocyanine blue, pigment blue, brilliant green B, phthalocyanine green, quinacridone, and the like can be used alone or in admixture.

To the developing agent according to this embodiment, a wax can also be added.

Examples of the wax include aliphatic hydrocarbon-based waxes such as low-molecular weight polyethylene waxes, low-molecular weight polypropylene waxes, polyolefin copolymer waxes, polyolefin waxes, microcrystalline waxes, paraffin waxes, and Fischer-Tropsch waxes; oxides of aliphatic hydrocarbon-based waxes such as polyethylene oxide waxes or block copolymers, thereof; vegetable waxes such as candelilla wax, carnauba wax, Japan wax, jojoba wax, and rice wax; animal waxes such as bees wax, lanolin, and spermaceti wax; mineral waxes such as ozokerite, ceresin, and petrolactam; waxes containing, as a main component, a fatty acid ester such as montanic acid ester wax and castor wax; and materials obtained by deoxidation of a part or the whole of a fatty acid ester such as deoxidized carnauba wax.

As a charge control agent, a metal-containing azo compound can be used. As the metal element of the metal-containing azo compound, for example, a complex or a complex salt of iron, cobalt, or chromium, a mixture thereof, etc. can be exemplified. Further, a metal-containing salicylic acid derivative compound can be used. As the metal element of the metal-containing salicylic acid derivative compound, for example, a complex or a complex salt of zirconium, zinc, chromium, or boron, a mixture thereof, etc. can be exemplified.

In order to adjust the fluidity or chargeability of toner particles, inorganic fine particles can be mixed in the surfaces of the toner particles. As such inorganic fine particles, for example, silica, titania, alumina, strontium titanate, tin oxide, and the like can be used alone or by mixing two or more types thereof. As the inorganic fine particles, those surface-treated with a hydrophobizing agent can be used from the viewpoint of improvement of environmental stability. Further, other than such inorganic oxides, resin fine particles having a size of 1 μm or less can be added for improving the cleaning property.

In order to form the surface layer to be used in this embodiment, a method in which a reaction is performed on the surfaces of the toner core particles is used. From the viewpoint of safety and the like, it is possible to perform the reaction by mixing a water-soluble crosslinking agent which crosslinks with a carboxyl group of the binder resin and a water-soluble polymer having a carboxyl group (hereinafter referred to as “a polycarboxylic acid”) in water.

The type of the water-soluble polymeric crosslinking agent which crosslinks with a carboxyl group to be used in this embodiment is not particularly limited as long as the agent is a polymer which reacts with a carboxyl group. Examples of the water-soluble polymeric crosslinking agent which crosslinks with a carboxyl group include isocyanate-based crosslinking agents, oxazoline-based crosslinking agents, aziridine-based crosslinking agents, and carbodiimide-based crosslinking agents. The molecular weight of the water-soluble polymeric crosslinking agent can be set to 1000 to 1,000,000. From the viewpoint of safety and chargeability, a water-soluble polymer having an oxazoline group, which is an oxazoline-based crosslinking agent, or a water-soluble polymer having a carbodiimide group, which is a carbodiimide-based crosslinking agent, can be selected. Specific examples of the water-soluble polymeric crosslinking agent include CARBODILITE SV-02, V-02, V02-L2, and V-04, all of which are manufactured by Nisshinbo Chemical Inc., and EPOCROS WS300, WS500, and WS700, all of which are manufactured by Nippon Shokubai Co., Ltd.

The water-soluble polymer having a carboxyl group to be used in this embodiment is a water-soluble polymer having a carboxyl group per molecule. Examples of the water-soluble polymer having a carboxyl group include polymers formed from acrylic acid, methacrylic acid, fumaric acid, maleic acid, aspartic acid, crotonic acid, itaconic acid, or citraconic acid as a monomer, copolymers formed therefrom, metal salts thereof, ammonium salts thereof, esterification products thereof, and mixtures of polymers formed therefrom. The molecular weight thereof can be set to 1000 to 1,000,000, and the acid value thereof can be set to 10 to 10,000. Further, if the water-soluble polymer having a carboxylic group is a metal salt or an ammonium salt, the crosslinking reaction is inhibited, and therefore, it can be not to use a material in which all of the carboxyl groups were substituted with a salt. Such a condition can be adjusted through pH adjustment, however, the pH during the reaction can be set to 2 to 12, preferably 2 to 10.

In the method for producing a developing agent according to this embodiment, first, toner core particles are produced.

As a method for producing the toner core particles, for example, a kneading pulverization method, a suspension polymerization method, an aggregation method, and a dissolution suspension method can be used. When the toner core particles are in the form of a powder, the particles can be dispersed using a dispersing agent such as a surfactant.

At this time, if the particles are dispersed in an aqueous medium using the water-soluble polymeric crosslinking agent or the water-soluble polymer having a carboxyl group, the crosslinking reaction can be efficiently performed.

On the other hand, in the case of using the toner core particles produced by a chemical production method such as a suspension polymerization method, an aggregation method, or a dissolution suspension method, it is also possible to perform the crosslinking reaction by adding the water-soluble polymeric crosslinking agent or the water-soluble polymer having a carboxyl group in a state where the toner core particles are dispersed in water before being subjected to washing and drying.

The storage stability refers to the performance capable of withstanding a temperature in the main body of an MFP and a temperature during transportation, and is the performance of a toner such that the toner is not aggregated or solidified under a high temperature.

A storage stability test and an evaluation method therefor are as follows. First, 20 g of a toner is put in a 100-cc polyethylene bottle and the bottle is left in a constant temperature bath which is set to a predetermined temperature for 8 hours. Thereafter, the toner is sieved for 10 seconds at 0.6 mm P-P in a powder tester PT-E (manufactured by Hosokawa Micron Corporation) in which a 42-mesh sieve is disposed, and the weight of the toner remaining on the sieve is measured. When the amount of the toner remaining on the sieve is large, the toner is evaluated to have poor storage stability. The case where the weight of the toner remaining on the sieve is 1 g or less is evaluated as good, and the case where the weight thereof exceeds 1 g is evaluated as poor.

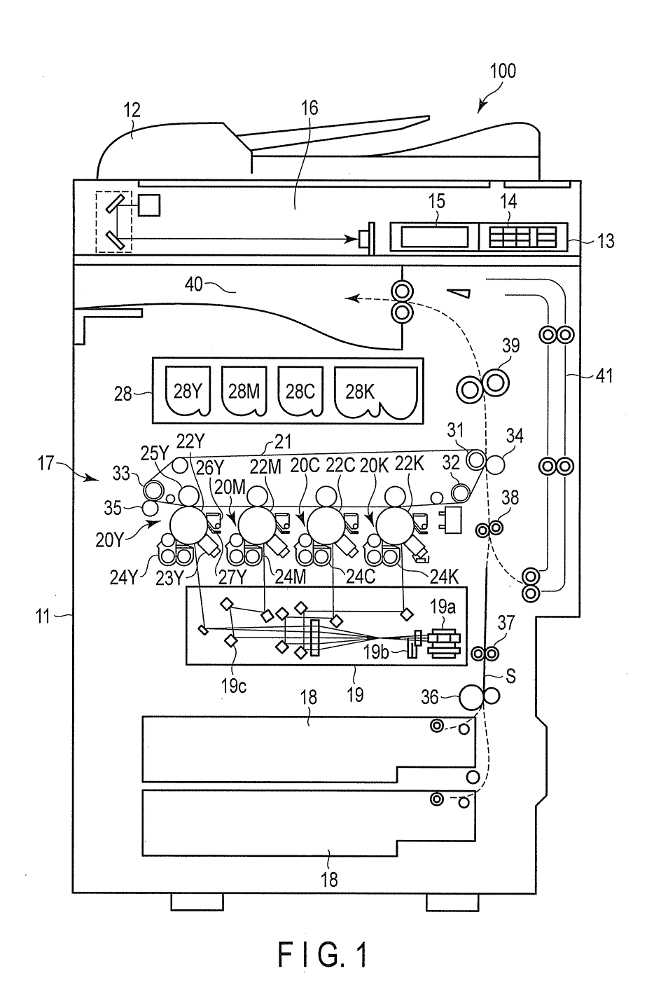

FIG. 1 is a schematic view showing an exemplary image forming apparatus according to this embodiment.

An image erasing method according to this embodiment can be performed using a fixing device of the image forming apparatus.

As shown in FIG. 1, an image forming apparatus 100 is, for example, an MFP (multifunction peripherals) as a complex machine, a printer, a copier, or the like. In the following description, an MFP is described as an example of the image forming apparatus. At an upper part of a main body 11 of an MFP 100, a document table (not shown) is provided, and on the document table, an automatic document feeder (ADF) 12 is openably and closably provided. Further, an operation panel 13 is provided at an upper part of the main body 11. The operation panel 13 is provided with an operation section 14 including various keys and a display section 15 of a touch panel type.

A scanner section 16 is provided below the ADF 12 in the main body 11. The scanner section 16 scans a document fed by the ADF 12 or a document placed on the document table and generates image data. Further, a printer section 17 is provided in the center in the main body 11, and a plurality of cassettes 18 which store sheets of various sizes are provided at a lower part of the main body 11.

The printer section 17 includes photoconductive drums, lasers, and the like, and processes image data scanned by the scanner section 16 or image data created by a PC (personal computer) or the like and forms an image on a sheet.

The sheet having an image formed thereon by the printer section 17 is discharged to a paper discharge section 40. The printer section 17 is, for example, a color laser printer of a tandem system, and scans a photoconductor with a laser beam from a laser exposing device 19 and generates an image.

The printer section 17 includes image forming sections 20Y, 20M, 20C, and 20K for respective colors of yellow (Y), magenta (M), cyan (C), and black (K). The image forming sections 20Y, 20M, 20C, and 20K are arranged in parallel below an intermediate transfer belt 21 from an upstream side to a downstream side.

Since the image forming sections 20Y, 20M, 20C, and 20K have the same structure, the image forming section 20Y will be described below as a representative image forming section.

The image forming section 20Y has a photoconductive drum 22Y which is an image carrying member, and around the photoconductive drum 22Y, an electrifying charger 23Y, a developing device 24Y, a primary transfer roller 25Y, a cleaner 26Y, a blade 27Y, and the like are arranged along the rotating direction t of the photoconductive drum 22Y. An area at an exposure position of the photoconductive drum 22Y is irradiated with a yellow laser beam from the laser exposing device 19 to form an electrostatic latent image on the photoconductive drum 22Y.

The electrifying charger 23Y of the image forming section 20Y uniformly charges the entire surface of the photoconductive drum 22Y. The developing device 24Y supplies a two-component developing agent composed of a yellow toner and a carrier to the photoconductive drum 22Y using a developing roller to which a developing bias is applied to form a toner image. The cleaner 26Y removes the residual toner on the surface of the photoconductive drum 22Y using the blade 27Y.

Above the respective image forming sections 20Y, 20M, 20C, and 20K, the developing devices 24Y, 24M, 24C, and 24K which contain each of the toners according to this embodiment of the respective colors of yellow (Y), magenta (M), cyan (C), and black (K) and a toner cartridge 28 (FIG. 1) which supply the toners of the respective colors are provided. The toner cartridge 28 includes toner cartridges 28Y, 28M, 28C, and 28K for the respective colors of yellow (Y), magenta (M), cyan (C), and black (K), which are adjacent to one another.

The intermediate transfer belt 21 cyclically moves, and for example, semi-conductive polyimide is used from the viewpoint of heat resistance and abrasion resistance. The intermediate transfer belt 21 is reeved around a driving roller 31 and driven rollers 32 and 33 and faces and is in contact with the photoconductive drums 22Y to 22K. A primary transfer voltage is applied to the intermediate transfer belt 21 at a position facing the photoconductive drum 22Y by the primary transfer roller 25Y to primarily transfer the toner image on the photoconductive drum 22Y onto the intermediate transfer belt 21.

A secondary transfer roller 34 is arranged facing the driving roller 31 around which the intermediate transfer belt 21 is reeved. When the sheet S passes between the driving roller 31 and the secondary transfer roller 34, a secondary transfer voltage is applied to the sheet S by the secondary transfer roller 34 to secondarily transfer the toner image on the intermediate transfer belt 21 onto the sheet S. A belt cleaner 35 is provided near the driven roller 33 of the intermediate transfer belt 21.

On the other hand, the laser exposing device 19 includes a polygon mirror 19a, an imaging lens system 19b, a mirror 19c, and the like, and scans a laser beam emitted from a semiconductor laser element in the axial direction of the photoconductive drum 22.

Further, as shown in FIG. 1, a separation roller 36 which extracts the sheet S in the paper feed cassette 18, conveying rollers 37, and resist rollers 38 are provided between the paper feed cassette 18 and the secondary transfer roller 34. Further, a fixing device 39 is provided downstream of the secondary transfer roller 34.

The paper discharge section 40 and a reverse conveyance path 41 are provided downstream of the fixing device 39. The sheet S is discharged to the paper discharge section 40 from the fixing device 39. The reverse conveyance path 41 is used when duplex printing is performed and is configured to reverse the sheet S and then guide the sheet in the direction of the secondary transfer roller 34.

Next, operations of the image forming apparatus 100 shown in FIG. 1 will be described. When image data is input from the scanner 16, PC, or the like, images are sequentially formed by the image forming sections 20Y to 20K. When the image forming section 20Y is described as an example, the photoconductive drum 22Y is irradiated with a laser beam corresponding to yellow (Y) image data and an electrostatic latent image is formed thereon. Further, the electrostatic latent image on the photoconductive drum 22Y is developed by the developing device 24Y, whereby a yellow (Y) toner image is formed.

The photoconductive drum 22Y comes into contact with the rotating intermediate transfer belt 21 and primarily transfers the yellow (Y) toner image onto the intermediate transfer belt 21 using the primary transfer roller 25Y. After the toner image is primarily transferred onto the intermediate transfer belt 21, the residual toner on the photoconductive drum 22Y is removed by the cleaner 26Y and the blade 27Y. Accordingly, the photoconductive drum 22Y can be used for the subsequent image formation.

In the same manner as the process for forming the yellow (Y) toner image, magenta (M), cyan (C), and black (K) toner images are formed by the image forming sections 20M to 20K. The respective toner images are sequentially transferred onto the intermediate transfer belt 21 at the same position where the yellow (Y) toner image is transferred. The yellow (Y), magenta (M), cyan (C), and black (K) toner images are transferred in a superimposed manner onto the intermediate transfer belt 21, whereby a full-color toner image is obtained.

The full-color toner image on the intermediate transfer belt 21 is secondarily transferred onto the sheet S collectively by a transfer bias of the secondary transfer roller 34. The sheet S is fed from the paper feed cassette 18 to the secondary transfer roller 34 synchronously with the full-color toner image on the intermediate transfer belt 21 reaching the secondary transfer roller 34.

The sheet S having the toner image secondarily transferred thereto reaches the fixing device 39 and the toner image is fixed thereon.

The sheet S having the toner image fixed thereon is discharged to the paper discharge section 40. On the other hand, after the secondary transfer is completed, the residual toner on the intermediate transfer belt 21 is cleaned by the belt cleaner 35.

When the image is erased, for example, the sheet on which the image is to be erased is placed in the paper feed cassette 18, conveyed from the cassette, whereby the paper can be introduced into the fixing device 39. At this time, a toner image is not formed by the image forming sections 20Y to 20K.

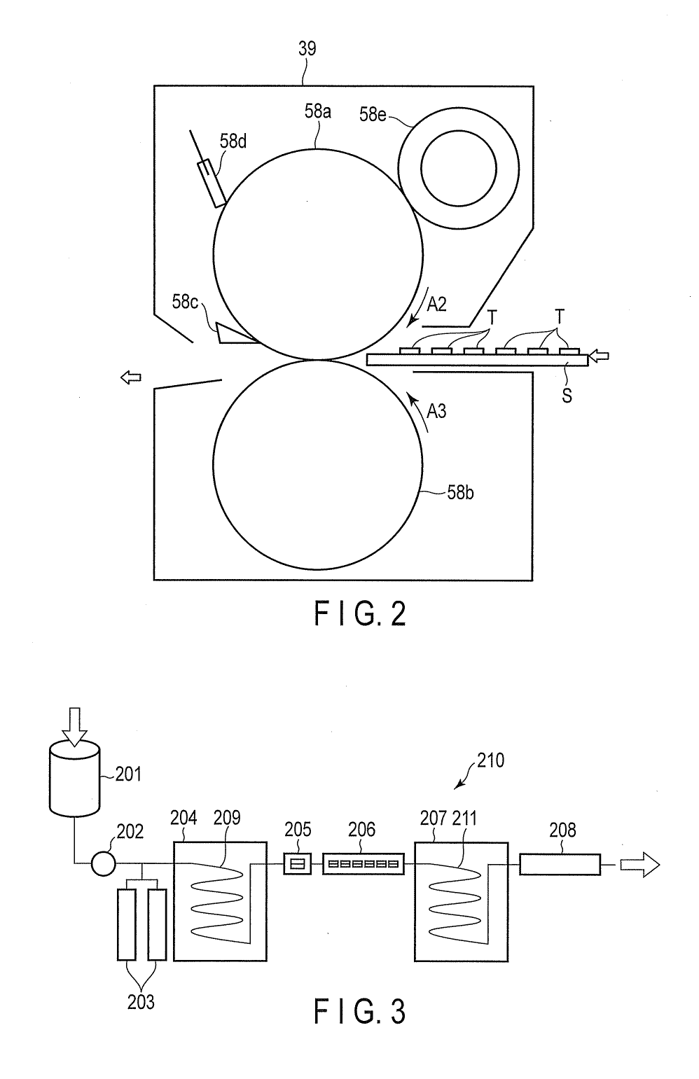

Further, FIG. 2 shows a schematic view of the fixing device shown in FIG. 1.

FIG. 2 is a view showing a specific structure of a fixing device 39.

The fixing device 39 includes a heating roller 58a, a pressing roller 58b, a separation pawl 58c, a cleaning member 58d, and an applying roller 58e.

The heating roller 58a has a built-in heat source such as a halogen lamp. The pressing roller 58b is arranged substantially parallel to the heating roller 58a and is in contact with the heating roller 58a in a state pressed by a pressing mechanism (not shown). The heating roller 58a is supported rotatably about the axis thereof as the rotation axis and is rotated in the direction indicated by the arrow A2 by a rotating mechanism (not shown). The pressing roller 58b is supported rotatably about the axis thereof as the rotation axis and is rotated in the direction indicated by the arrow A3 by the rotation of the heating roller 58a. A recording sheet S sent by a conveying belt 64 is inserted between the heating roller 58a and the pressing roller 58b. When an image is formed, the fixing device 39 melts and fixes a toner T electrostatically adhering to the recording sheet S by heat generated by the heating roller 58a and pressure applied by the heating roller 58a and the pressing roller 58b. On the other hand, when an image is erased, the toner T fixed on the recording sheet S is decolored by the heat generated by the heating roller 58a and if necessary by the pressure applied by the pressing roller 58b, whereby the image is erased. At this time, the heating temperature by the heating roller can be made higher than the fixing temperature of the toner.

The separation pawl 58c separates the recording sheet S from the heating roller 58a.

The cleaning member 58d removes the toner, paper powder, etc. adhering to the heating roller 58a.

The applying roller 58e is arranged substantially parallel to the heating roller 58a and in contact with the heating roller 58a. The applying roller 58e applies a release oil to the surface of the heating roller 58a.

As the release oil, for example, silicone oil or the like can be used.

Hereinafter, embodiments will be specifically described with reference to Examples.

### Preparation of Core Particles 1

Polyester resin (Mw: 16000, Tg: 61° C., Tm: 110° C., AV: 20): 90 parts by weight

Pigment blue 15:3 (manufactured by Clariant Co., Ltd.): 5 parts by weight

Rice wax: 5 parts by weight

After the above components were mixed, the resulting mixture was melt-kneaded using a twin-screw kneader which was set to a temperature of 120° C., whereby a kneaded material was obtained.

The thus obtained kneaded material was coarsely crushed to a volume average particle diameter of 0.1 mm or less using a bantam mill manufactured by Hosokawa Micron Corporation, whereby coarse particles were obtained.

Parts by weight of the thus obtained coarse particles of the mixture were mixed with 3 parts by weight of sodium dodecylbenzene sulfonate as a surfactant, 2 parts by weight of dimethylaminoethanol as an alkaline pH adjusting agent, and 65 parts by weight of ion exchanged water, whereby a dispersion liquid was prepared.

Subsequently, the above-prepared dispersion liquid of the coarse particles was subjected to a pulverization treatment at 180° C. and 150 MPa using a high-pressure wet-type pulverizer NANO 3000. After the pressure was reduced while maintaining the temperature at 180° C., the dispersion liquid was cooled to 30° C., whereby a dispersion liquid of fine particles was obtained. The diameter of the thus obtained particles was measured using SALD-7000 manufactured by Shimadzu Corporation and found to be 0.52 μm.

FIG. 3 is a schematic view showing an exemplary structure of NANO 3000 which can be used in the production of the developing agent according to this embodiment.

A high-pressure homogenizer 210, which is one example of the high-pressure wet-type pulverizer, has a structure in which a hopper tank 201, a liquid feed pump 202, a high-pressure pump 203, a heating section 204, a pulverizing section 205, a depressurizing section 206, a cooling section 207, and a depressurizing section 208 are arranged in this order, and includes pipes which connect the respective sections.

The hopper tank 201 is a tank to which a process liquid is fed. While the device is being operated, it is necessary to always fill the tank with a liquid so as not to send air into the device. When the particles in the process liquid have a large particle diameter and are likely to precipitate, a stirrer may be further provided in the tank.

The liquid feed pump 202 is provided for continuously feeding the process liquid to the high-pressure pump 203. Further, this liquid feed pump 202 is also effective in avoiding clogging of a check valve (not shown) provided in the high-pressure pump 203. As the pump 202, for example, a diaphragm pump, a tubing pump, a gear pump, or the like can be used.

The high-pressure pump 203 is a plunger pump and has check valves at a process liquid inlet port (not shown) and a process liquid outlet port (not shown). The number of plungers varies depending on the production scale, and one to ten plungers are used. In order to reduce a pulsating current as much as possible, two or more plungers can be used.

The heating section 204 is provided with a high-pressure pipe 209 formed in a spiral shape so as to have a large heat exchange area in a heating device such as an oil bath. It does not matter whether this heating section 204 is disposed on the upstream side or downstream side of the high-pressure pump 203 in the flow direction of the dispersion liquid, however, it is necessary to dispose this heating section 204 at least on the upstream side of the pulverizing section 205. When the heating section 204 is disposed on the upstream side of the high-pressure pump 203, a heating device may be provided in the hopper tank 201, however, the time for which the process liquid is retained at a high temperature is long, and therefore, thermal decomposition is likely to occur.

The pulverizing section 205 includes a nozzle having a small diameter for applying a strong shearing force. The diameter and shape of the nozzle vary, however, the diameter thereof can be from 0.05 mm to 0.5 mm, and as for the shape thereof, a pass-through type nozzle or a collision type nozzle can be used. Further, this nozzle may be configured in a multiple-stage structure. When a multiple-stage structure is employed, a plurality of nozzles having different diameters may be arranged. As for the configuration of the arrangement of such nozzles, either series or parallel configuration may be employed. As the material of the nozzle, diamond or the like which can withstand a high pressure is used.

The cooling section 207 is provided with a pipe 211 formed in a spiral shape so as to have a large heat exchange area in a bath in which cold water is allowed to continuously flow.

According to need, depressurizing sections 206 and 208 can be provided upstream and downstream of the cooling section 207. The depressurizing sections 206 and 208 have a structure in which one or more cells or two-way valves having a flow path which is larger than the diameter of the nozzle of the pulverizing section 205 and smaller than the diameter of the pipe connected thereto are arranged.

A high-pressure pipe for heat exchange having a length of 12 m immersed in an oil bath as the heating section 204, a high-pressure pipe including nozzles having diameters of 0.13 μm and 0.28 μm, respectively, arranged in a row as the pulverizing section 205, a medium-pressure pipe including cells having pore diameters of 0.4, 1.0, 0.75, 1.5, and 1.0 μm, respectively, arranged in a row as the depressurizing section 206, and a heat exchange pipe having a length of 12 m capable of cooling with tap water as the cooling section 207 are provided.

Parts by weight of the thus obtained dispersion liquid of fine particles and 65 parts by weight of ion exchanged water were mixed with each other, and while stirring the resulting mixture at 6500 rpm in a homogenizer (T25) manufactured by IKA Japan K.K., 10 parts by weight of an aqueous solution of 5% aluminum sulfate as an aggregating agent was added thereto, and then, the resulting dispersion liquid was placed in an aggregation reactor.

Thereafter, 20 parts by weight of an aqueous solution of 10% sodium polycarboxylate as a stabilizing agent was added thereto, and the resulting mixture was further heated to 95° C., whereby aggregated and fused particles were obtained. The particle diameter of the aggregated and fused particles was measured using Multisizer 3 manufactured by Beckman Coulter, Inc., and it was found that the 50% volume average diameter Dv was 5.1 μm, the 50% number average diameter Dp was 4.5 μm, and the particles had a sharp particle size distribution. The solid component in the thus obtained dispersion liquid was subjected to repeating filtration and washing with ion exchanged water until the electrical conductivity of the filtrate became 50 μS/cm. Thereafter, the washed solid component was dried using a vacuum dryer until the water content became 1.0% by weight or less, whereby core particles 1 were obtained.

### Preparation of Core Particles 2

Polyester resin (Mw: 16000, Tg: 61° C., Tm: 110° C., AV: 20): 90 parts by weight

Pigment blue 15:3 (manufactured by Clariant Co., Ltd.): 5 parts by weight

Rice wax: 5 parts by weight

After the above components were mixed, the resulting mixture was melt-kneaded using a twin-screw kneader which was set to a temperature of 120° C., whereby a kneaded material was obtained. The thus obtained kneaded material was crushed and classified, whereby core particles 2 having a volume average particle diameter of 5.0 μm were obtained.

### Preparation of Core Particles 3

Polyester resin (Mw: 16000, Tg: 61° C., Tm: 110° C., AV: 20): 95 parts by weight

Pigment blue 15:3 (manufactured by Clariant Co., Ltd.): 5 parts by weight

After the above components were mixed, the resulting mixture was melt-kneaded using a twin-screw kneader which was set to a temperature of 120° C., whereby a kneaded material was obtained.

The thus obtained kneaded material was coarsely crushed to a volume average particle diameter of 0.1 mm or less using a bantam mill manufactured by Hosokawa Micron Corporation, whereby coarse particles were obtained.

By using the thus obtained coarse particles of the mixture, core particles 3 without containing a wax were obtained in the same manner as the preparation of the core particles 1.

### Example 1

Core particles 1: 10 parts by weight

Crosslinking agent: an aqueous solution of a water-soluble acrylic polymer having an oxazoline group, EPOCROS WS700 manufactured by Nippon Shokubai Co., Ltd.: 1.5 parts by weight

Ion exchanged water: 89 parts by weight

The above components were mixed and dispersed, and then, the pH of the resulting dispersion was adjusted to 10 with an aqueous solution of 10% sodium hydroxide. Then, the dispersion was heated to 80° C. while stirring the dispersion with a paddle blade. After the temperature reached 80° C., 1 part by weight of an aqueous solution of 10% polycarboxylic acid (polyacrylic acid Aqualic HL 415 (molecular weight: 10000) manufactured by Nippon Shokubai Co., Ltd.) was added thereto, and the resulting mixture was left at 80° C. for 1 hour, and the crosslinking reaction was completed. Thereafter, the solid component in the thus obtained dispersion liquid was subjected to repeating filtration and washing with ion exchanged water until the electrical conductivity of the filtrate became 50 μS/cm.

Then, the washed solid component was dried using a vacuum dryer until the water content became 1.0% by weight or less, whereby dried particles were obtained.

After the drying, 2 parts by weight of hydrophobic silica and 0.5 parts by weight of titanium oxide were attached as additives to the surfaces of the toner particles, whereby a desired electrophotographic toner was obtained.

The obtained electrophotographic toner was placed in a modified apparatus obtained by modifying an MFP e-STUDIO 3520c manufactured by Toshiba Tec Corporation for evaluation, and an unfixed solid image was formed at an attached amount of 1.6±0.05 mg/cm² on A4 size sheet with a weight of 64 g. Then, in a fixing device (200 mm/s) modified for evaluation, a silicone oil applying roller was placed, and fixability was evaluated by changing the temperature, whereby a fixing temperature range was determined as the evaluation for the fixability. Further, the above-described storage stability test was performed. The obtained results are shown in the following Table 1.

### Example 2

Core particles 2: 10 parts by weight

Crosslinking agent: EPOCROS WS700 manufactured by Nippon Shokubai Co., Ltd.: 1.5 parts by weight

Ion exchanged water: 89 parts by weight

The above components were mixed and dispersed, and then, the pH of the resulting dispersion was adjusted to 10 with an aqueous solution of 10% sodium hydroxide. Then, the dispersion was heated to 80° C. while stirring the dispersion with a paddle blade. After the temperature reached 80° C., 1 part by weight of an aqueous solution of 10% polycarboxylic acid (polyacrylic acid Aqualic HL 415 (molecular weight: 10000) manufactured by Nippon Shokubai Co., Ltd.) was added thereto, and the resulting mixture was left at 80° C. for 1 hour, and the crosslinking reaction was completed. Thereafter, the solid component in the thus obtained dispersion liquid was subjected to repeating filtration and washing with ion exchanged water until the electrical conductivity of the filtrate became 50 μS/cm.

Then, the washed solid component was dried using a vacuum dryer until the water content became 1.0% by weight or less, whereby dried particles were obtained.

After the drying, 2 parts by weight of hydrophobic silica and 0.5 parts by weight of titanium oxide were attached as additives to the surfaces of the toner particles, whereby a desired electrophotographic toner was obtained.

For the obtained electrophotographic toner, the fixability evaluation and the storage stability test were performed in the same manner as in Example 1.

### Example 3

Core particles 3: 10 parts by weight

Crosslinking agent: EPOCROS WS700 manufactured by Nippon Shokubai Co., Ltd.: 1.5 parts by weight

Ion exchanged water: 89 parts by weight

The above components were mixed and dispersed, and then, the pH of the resulting dispersion was adjusted to 10 with an aqueous solution of 10% sodium hydroxide. Then, the dispersion was heated to 80° C. while stirring the dispersion with a paddle blade. After the temperature reached 80° C., 1 part by weight of an aqueous solution of 10% polycarboxylic acid (polyacrylic acid Aqualic HL 415 (molecular weight: 10000) manufactured by Nippon Shokubai Co., Ltd.) was added thereto, and the resulting mixture was left at 80° C. for 1 hour, and the crosslinking reaction was completed. Thereafter, the solid component in the thus obtained dispersion liquid was subjected to repeating filtration and washing with ion exchanged water until the electrical conductivity of the filtrate became 50 μS/cm.

Then, the washed solid component was dried using a vacuum dryer until the water content became 1.0% by weight or less, whereby dried particles were obtained.

After the drying, 2 parts by weight of hydrophobic silica and 0.5 parts by weight of titanium oxide were attached as additives to the surfaces of the toner particles, whereby a desired electrophotographic toner was obtained.

For the obtained electrophotographic toner, the fixability evaluation and the storage stability test were performed in the same manner as in Example 1.

### Example 4

Core particles 1: 10 parts by weight

Crosslinking agent: an aqueous solution of a polymer having a carbodiimide group, CARBODILITE V02-L2, manufactured by Nisshinbo Chemical Inc.: 0.36 parts by weight

Ion exchanged water: 89.19 parts by weight

The above components were mixed and dispersed, and then, the pH of the resulting dispersion was adjusted to 10 with an aqueous solution of 10% sodium hydroxide. Then, the dispersion was heated to 80° C. while stirring the dispersion with a paddle blade. After the temperature reached 80° C., 0.45 parts by weight of an aqueous solution of 10% polycarboxylic acid (Aqualic HL 415 (molecular weight: 10000)) was added thereto, and the resulting mixture was left at 80° C. for 3 hours, and the crosslinking reaction was completed. Thereafter, the solid component in the thus obtained dispersion liquid was subjected to repeating filtration and washing with ion exchanged water until the electrical conductivity of the filtrate became 50 μS/cm. Then, the washed solid component was, dried using a vacuum dryer until the water content became 1.0% by weight or less, whereby dried particles were obtained.

After the drying, 2 parts by weight of hydrophobic silica and 0.5 parts by weight of titanium oxide were attached as additives to the surfaces of the toner particles, whereby a desired electrophotographic toner was obtained.

The obtained electrophotographic toner was placed in a modified apparatus obtained by modifying an MFP e-STUDIO 3520c manufactured by Toshiba Tec Corporation for evaluation, and an unfixed solid image was formed at an attached amount of 1.6±0.05 mg/cm² on A4 size sheet with a weight of 64 g. Then, in a fixing device (200 mm/s) modified for evaluation, a silicone oil applying roller was placed, and fixability was evaluated by changing the temperature. Further, the above-described storage stability test was performed.

### Example 5

Core particles 1: 10 parts by weight

Crosslinking agent: EPOCROS WS700 manufactured by Nippon Shokubai Co., Ltd.: 0.36 parts by weight

Ion exchanged water: 89.19 parts by weight

The above components were mixed and dispersed, and then, the pH of the resulting dispersion was adjusted to 10 with an aqueous solution of 10% sodium hydroxide. Then, the dispersion was heated to 80° C. while stirring the dispersion with a paddle blade. After the temperature reached 80° C., 0.45 parts by weight of an aqueous solution of 10% polycarboxylic acid (polyacrylic acid Aqualic AS 58 (molecular weight: 800000) manufactured by Nippon Shokubai Co., Ltd.) was added thereto, and the resulting mixture was left at 80° C. for 3 hours, and the crosslinking reaction was completed. Thereafter, the solid component in the thus obtained dispersion liquid was subjected repeating filtration and washing with ion exchanged water until the electrical conductivity of the filtrate became 50 μS/cm. Then, the washed solid component was dried using a vacuum dryer until the water content became 1.0% by weight or less, whereby dried particles were obtained.

After the drying, 2 parts by weight of hydrophobic silica and 0.5 parts by weight of titanium oxide were attached as additives to the surfaces of the toner particles, whereby a desired electrophotographic toner was obtained.

The obtained electrophotographic toner was placed in a modified apparatus obtained by modifying an NFP e-STUDIO 3520c manufactured by Toshiba Tec Corporation for evaluation, and an unfixed solid image was formed at an attached amount of 1.6±0.05 mg/cm² on A4 size sheet with a weight of 64 g. Then, in a fixing device (200 mm/s) modified for evaluation, a silicone oil applying roller was placed, and fixability was evaluated by changing the temperature. Further, the above-described storage stability test was performed.

### Comparative Example 1

Core particles 1: 10 parts by weight

Crosslinking agent: EPOCROS WS700 manufactured by Nippon Shokubai Co., Ltd.: 1.5 parts by weight

Ion exchanged water: 89 parts by weight

The above components were mixed and dispersed, and then, the pH of the resulting dispersion was adjusted to 10 with an aqueous solution of 10% sodium hydroxide. Then, the dispersion was heated to 80° C. while stirring the dispersion with a paddle blade. After the temperature reached 80° C., 1 part by weight of an aqueous solution of 10% polycarboxylic acid (polyacrylic acid (molecular weight: 10000)) was added thereto, and the resulting mixture was left at 80° C. for 1 hour, and the crosslinking reaction was completed.

Thereafter, the solid component in the thus obtained dispersion liquid was subjected to repeating filtration and washing with ion exchanged water until the electrical conductivity of the filtrate became 50 μS/cm. Then, the washed solid component was dried using a vacuum dryer until the water content became 1.0% by weight or less, whereby dried particles were obtained.

After the drying, 2 parts by weight of hydrophobic silica and 0.5 parts by weight of titanium oxide were attached as additives to the surfaces of the toner particles, whereby a desired electrophotographic toner was obtained.

For the obtained electrophotographic toner, the fixability evaluation and the storage stability test were performed in the same manner as in Example 1.

### Comparative Example 2

To the core particles 1, 2 parts by weight of hydrophobic silica and 0.5 parts by weight of titanium oxide were attached as additives to the surfaces of the toner particles, whereby a desired electrophotographic toner was obtained.

For the obtained electrophotographic toner, the fixability evaluation and the storage stability test were performed in the same manner as in Example 1.

The results of the fixability and the storage stability of the above Examples are shown in the following Table 1.

TABLE 1

| | | | Oil for | Fixing | Storage stability |
|---|---|---|---|---|---|
| | | Surface | fixing | temperature | (evaluation at |
| | Core particles | treatment | device | range | 60° C.) |
| Example 1 | Core particles 1 | With | With | 135 to 180° C. | good |
| Example 2 | Core particles 2 | With | With | 135 to 180° C. | good |
| Example 3 | Core particles 3 | With | With | 135 to 160° C. | good |
| Example 4 | Core particles 1 | With | With | 130 to 160° C. | good |
| Example 5 | Core particles 2 | With | With | 140 to 190° C. | good |
| Comparative | Core particles 1 | With | Without | None | good |
| Example 1 | | | | | |
| Comparative | Core particles 1 | Without | Without | 130 to 170° C. | poor |
| Example 2 | | | | | |

By using the encapsulated toner according to this embodiment, there was no defective fixing in fixing temperature range, and the storage stability was improved.

Further, by applying an oil, the fixability was improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A developing agent to be fixed by a fixing device having a release oil applied thereto, comprising
a toner core particle containing a binder resin having a carboxyl group and a coloring agent, and
a surface layer formed on the toner core particle by crosslinking toner core particles, a water-soluble polymeric crosslinking agent which is crosslinkable with a carboxyl group, and a water-soluble polymer having a carboxyl group in an aqueous medium.

2. The developing agent according to claim 1, wherein the water-soluble polymeric crosslinking agent which is crosslinkable with a carboxyl group is at least one material selected from the group consisting of isocyanate-based crosslinking agents, oxazoline-based crosslinking agents, aziridine-based crosslinking agents, and carbodiimide-based crosslinking agents.

3. The developing agent according to claim 1, wherein the water-soluble polymer having a carboxyl group is at least one material selected from the group consisting of polymers formed from acrylic acid, methacrylic acid, fumaric acid, maleic acid, aspartic acid, crotonic acid, itaconic acid, or citraconic acid as a monomer, copolymers formed therefrom, metal salts thereof, ammonium salts thereof, esterification products thereof, and mixtures of polymers formed therefrom.

4. The developing agent according to claim 1, wherein the binder resin having a carboxyl group is selected from the group consisting of polyester resins, styrene-acrylic resins, polyurethane resins, and epoxy resins.

5. An image forming apparatus, comprising:
an image carrying member;
a developing device which is provided facing the image carrying member and contains a developing agent including a toner core particle containing a binder resin having a carboxyl group and a coloring agent, and a surface layer formed on the toner core particle by crosslinking toner core particles, a water-soluble polymeric crosslinking agent which is crosslinkable with a carboxyl group, and a water-soluble polymer having a carboxyl group in an aqueous medium; and
a fixing device having a release oil application mechanism for applying a release oil.

6. The image forming apparatus according to claim 5, wherein the water-soluble polymeric crosslinking agent which crosslinks with a carboxyl group is at least one member selected from the group consisting of isocyanate-based crosslinking agents, oxazoline-based crosslinking agents, aziridine-based crosslinking agents, and carbodiimide-based crosslinking agents.

7. The image forming apparatus according to claim 5, wherein the water-soluble polymer having a carboxyl group is at least one member selected from the group consisting of polymers formed from acrylic acid, methacrylic acid, fumaric acid, maleic acid, aspartic acid, crotonic acid, itaconic acid, or citraconic acid as a monomer, copolymers formed therefrom, metal salts thereof, ammonium salts thereof, esterification products thereof, and mixtures of polymers formed therefrom.

8. The image forming apparatus according to claim 5, wherein the binder resin having a carboxyl group is selected from the group consisting of polyester resins, styrene-acrylic resins, polyurethane resins, and epoxy resins.
